(19) United States
(12) Patent Application Publication
(10) Pub. No.: US 2022/0084066 A1
(43) Pub. Date: Mar. 17, 2022

(54) System and method for managing advertising and information content, intended for positioning on the means of displaying information, with the possibility of evaluating the effectiveness of the displayed content

(71) Applicants: Alexandr Borisovich Kisko, Moscow (RU); Boris Kisko, Moscow (RU)

(72) Inventors: Alexandr Borisovich Kisko, Moscow (RU); Boris Kisko, Moscow (RU)

(21) Appl. No.: 17/113,061

(22) Filed: Dec. 6, 2020

Related U.S. Application Data
(63) Continuation-in-part of application No. 17/022,035, filed on Sep. 15, 2020, now abandoned.

(51) Int. Cl. G06Q 30/02; G06F 3/14; G06K 9/00; G06T 7/70; H04L 29/08; H04W 4/029

(52) U.S. Cl. CPC G06Q 30/0255; G06F 3/14; G06K 9/00335; G06K 9/00711; G06T 7/70; G06T 2207/30232; H04L 67/306; H04W 4/029; G06T 2207/30242; G06T 2207/10016; G06T 2207/30196; G06K 9/00778

(57) ABSTRACT

A method includes obtaining data on unique identifiers of mobile devices of potential content consumers located in the area of at least one information display means, with the formation of the corresponding identifier database; obtaining data on the profile of consumers corresponding to the received unique identifiers, with the formation of the corresponding database profiles; obtaining data on the content displayed on the information display means with the formation of the content database; establishing a connection of each identifier of a mobile device from the identifier database with the corresponding content of the information display means and the consumer profile from the corresponding databases; analysis of established relationships; content management based on the results of the analysis with the ability to evaluate its effectiveness.

### FIELD OF THE INVENTION

The present invention relates to the field of advertising and information services for the population, and in particular to methods of managing advertising and information content that provide the ability to analyze content marketing, individual marketing and evaluate the effectiveness of advertising and information campaigns (displayed content).

### BRIEF DESCRIPTION OF THE INVENTION

In modern conditions of mass advertising products, consumers often impose information on goods and services that are not relevant to the specific interests of the consumer. In this regard, targeted (targeted) advertising is gaining popularity, providing timely and relevant presentation of advertising information to potential consumers, which increases the return on investment of advertisers. Targeted advertising includes the choice of time and place for the advertisement to be shown to a potential audience member (target audience) based on various factors, such as demographics, purchase history, observed viewing behavior, etc. Focusing only on those audiences for which the advertisement is most likely will affect, the advertiser can also effectively spend their advertising resources.

To date, various methods and systems are known from the prior art that allow advertisers to target specific audiences that are most susceptible to advertising. Among the various types of information that advertisers use, potential customer location information can be especially valuable. Knowing where the potential consumer of specific advertising information is located allows you to more accurately focus on the likely desires or needs of the consumer and determine the availability of products and services nearby.

Thanks to more accurate geographic information and better control over the collection of geographic information, which allows more efficient use of information to improve ad targeting, advertisers can deliver advertisements that are even more relevant to consumers, and increase the likelihood that consumers will find advertising useful, and ultimately will purchase advertised products or services.

A known method and system for managing content is disclosed in United States Patent Publication No. US2009298514. The content is delivered to a screen or device that supports audio playback, which is viewed by the user, based on the proximity of the user's mobile phone to this screen or device. The proximity of the user to such a device at the point of presence is determined using a wireless protocol for accessing the MAC address or other mobile-specific identifier (DSI) phone, to track what users see on the screen or hear on a device with sound support, for example, in order to evaluate the effectiveness of advertising content. In this case, the identifier of the mobile device is also used to create a user profile. After creating a profile, they perform behavioral targeting, demographic targeting, geographical targeting and other types of advertising targeting near the user.

Another prior art reference, such as U.S. Pat. No. 6,484,148, teaches a system and method for displaying advertisements specifically designed for one or more persons within the advertising range of a display device based on information related to these persons. According to one preferred embodiment of the invention, signals from one or more of the closest personal mobile devices of individuals are received by a system that is configured to identify a consumer profile from a received signal. Such identification signals may include signals emitted by cell phones. As soon as the advertising device receives the identification signal (s) and identifies one or more persons, the device extracts information from the consumer profile database, which includes information relating to a particular person, and this information is used to select and display targeted advertising for that person.

Still another prior art reference is taught by Russian Patent Reference No. RU 2016142541A. This reference teaches a method of collecting information offline to provide audiences in online advertising companies and measuring the effectiveness of advertising. According to the method, measuring the effectiveness of targeted advertising is carried out by registering the presence in the location of the mobile device by one or more of the identifiers of the pair matching offline and online identifiers for a specified period of time or the volume of purchases, by measuring the conversion from online impressions to physical visits to the advertised location or location with the advertised product.

Still another prior art reference, such as method and system for the distribution of audiovisual information and verification of viewing, is taught by Russian Patent Reference No. RU2328830. Here, the display unit may contain blocks of sensors for collecting environmental data. In one embodiment, motion sensors are used to determine if a display is being viewed. In another embodiment, video sensors are used to determine if a display is being viewed and/or to determine the number of viewers. In other embodiments, there are sensors used to receive information from portable electronic devices (eg, cell phones, personal digital assistants, or laptop computers). Verified views are associated with a value that, in some embodiments, is combined with a base display value. For example, an advertiser must pay one amount for displaying their ads as part of a regular schedule, another (possibly additional) amount is charged based on the number of viewers when it is confirmed that viewers watched the advertisement. Another (possibly additional) amount is charged based on the demographic data of the audience when the demographic data of the audience is known. In various embodiments, additional amounts are charged based on the number of times the content was displayed, the number of times the content was viewed, the number of people who viewed the content, and/or the number of people corresponding to the target demographic data that viewed the content.

Known solutions are based, as a rule, on identifying the identifiers of mobile devices of users, which identify consumer profiles, their location and movement in space relative to the advertising or information design, etc., which are used in the future to analyze consumer behavior and determine the effectiveness of advertising support.

One of the problems of effective consumer advertising is related to the difficulty of identifying a consumer by his mobile device. Many operating systems contain tools that allow you to redefine the identifiers of a mobile device, such as hardware addresses of network interfaces (MAC addresses), so the MAC address does not always uniquely identify the device. Some mobile devices (for example, Apple) constantly change their MAC address when searching for wireless networks, which does not allow sensors to identify them, and, as a result, reduces the effectiveness of advertising.

It should be noted that tracking devices is possible in two modes: passive and active. In passive mode, when there is no Wi-Fi connection, the phones send “probe requests” containing the MAC addresses of the phones, tracking which you can identify devices nearby. However, with a constant change of the MAC address with each request, the ability to track disappears, in contrast to the active mode (when the user is connected to Wi-Fi), when the true MAC address is tracked.

Thus, the inability to track the MAC addresses of a number of mobile devices of users in passive mode reduces the number of monitored devices and, as a result, reduces the accuracy of the analysis of statistical data based on the identification of mobile devices of users.

The technical problem to which the invention is directed is the creation of a method for managing advertising and information content, without the shortcomings presented in the prior art systems and methods listed above, which allows evaluating the efficiency and effectiveness of advertising campaigns of advertisers by collecting and processing data about the target audience located near the means of displaying relevant advertising and information materials, analytics opportunities for potential audience.

### SUMMARY OF THE INVENTION

The claimed invention relates to the field of advertising and information services for the population, and in particular to methods of managing advertising and information content that provide the opportunity to analyze content marketing, individual marketing and evaluate the effectiveness of advertising and information campaigns (displayed content). The method includes obtaining data on unique identifiers of mobile devices of potential content consumers located in the area of at least one information display means, with the formation of the corresponding identifier database; obtaining data on the profile of consumers corresponding to the received unique identifiers, with the formation of the corresponding database profiles; obtaining data on the content displayed on the information display means with the formation of the content database; establishing a connection of each identifier of a mobile device from the identifier database with the corresponding content of the information display means and the consumer profile from the corresponding databases; analysis of established relationships; content management based on the results of the analysis with the ability to evaluate its effectiveness.

At the same time, to determine the true unique identifiers of consumer's mobile devices, they filter out randomized identifiers of consumer's mobile devices, including reading requests from a consumer's mobile device with a device for receiving and analyzing signals, and then extracting data from requests received for a certain period of time and comparing the extracted data from all requests received for a certain time interval, and the exclusion of requests with different identifiers m abundant devices and repeating data. 1 n.p.ph., 24 s.p.f., 2 ill.

In another aspect of the present invention, the method for managing advertising and information content for placement on an information display means, with the ability to evaluate the effectiveness of the displayed content and information display means. The method including the steps of obtaining data on the unique identifiers of mobile devices of potential content consumers located in the area of placement of at least one information display means, with the formation of the corresponding identifier database followed by obtaining consumer profile data corresponding to the obtained unique identifiers containing at least one type of information from the following list: demographic characteristics, payment history, browsing history, shopping habits, income, advertising preferences, types and characteristics of consumer's mobile devices, routes movement, time spent in the content visibility zone, repeatability of routes, with the formation of the corresponding database of profiles.

The method further includes the step of obtaining data on the content displayed on the information display means with the formation of the content database and establishing a connection of each identifier of a mobile device from the identifier database with the corresponding content of the information display means and the consumer profile from the corresponding databases. The method further includes the step of conducting analysis of the established relationships of identifiers to determine at least one criterion from the following list: the number of consumers who were near the means of display at various points in time, the number of target consumers who were near the means of displaying information while displaying content relevant to them, the total number of consumers and target consumers located near all information display facilities and information display facilities located in a specific area and particular locality and in a particular region, the number of impressions during finding content user about information display means.

The method further includes the step of processing content management based on the results of the analysis with the possibility of evaluating its effectiveness in order to obtain data about unique identifiers of mobile devices of consumers located in the area of displaying information display devices. The method further includes the step of providing at least one device for receiving and analyzing signals from consumer mobile devices is placed on each information display means, true identifiers of mobile devices are determined by this device consumers located in the coverage area of the device, while registering the time of reception of the signal from each mobile device and its corresponding unique location identifier of the reception signal.

The method further includes the step of obtaining data on the consumer profile containing information about travel routes, travel time, route repeatability, determine the location, direction of movement and speed of movement of the consumer's mobile device relative to the information display means based on the recorded values of the signal reception time from each mobile device and unique location identifiers signal reception.

The method further includes the step of obtaining data on the content displayed on the information display means and to establish its connection with the unique identifier of the consumer's mobile device, the time interval for the mobile device to be located near the information display means is determined and correlated with the data on the content of the displayed information and the exact time the information is displayed at the same time, to determine the true unique identifiers of mobile devices of consumers, they filter out randomized identifiers of mobile devices of consumers, including reading requests from a mobile device of a consumer by a device for receiving and analyzing signals, and then extracting data from requests received for a certain time interval and comparing the extracted data from all requests received for a certain time interval, and the exclusion of requests with different identifiers m abundant devices and repeating data.

The method further includes the step of assigning a unique identifier for each mobile device using the MAC address, IP address, TCP port number or any other identifier when using the MAC address as a unique identifier for mobile devices, Probe Request requests are used as requests from mobile devices of consumers, and data from WLAN Management data frames. a device for receiving and analyzing signals from mobile devices, consumers use a Wi-Fi radar or Wi-Fi scanner or Wi-Fi sniffer configured to operate in the scanning mode of mobile devices of consumers and also the devices with a MAC address derandomization algorithm are used to obtain true MAC addresses of mobile consumers' devices. When filtering randomized MAC addresses, a certain time interval is selected in accordance with the average time spent by the consumer's mobile device in the range of the device for receiving and analyzing signals.

In that in order to obtain data on unique identifiers of mobile devices of consumers, registration of request frames sent by mobile devices of consumers is carried out and further obtaining video data from a location area of the information display means. The video data is obtained using at least one video camera installed on or near the information display means, which determine the number of consumers in the camera's observation area for a certain period of time, and evaluate the direction consumer gaze and/or recognition of consumer emotions, the data obtained is used for subsequent statistical analysis and evaluation of the effectiveness of the displayed advertising information.

Based on the assessment of the direction of the gaze of consumers, an exception is made from the statistical analysis of random identifiers of mobile devices of consumers who did not interact with the means for displaying advertising information. The consumer uses a smartphone, personal digital assistant (PDA), tablet computer, smart watch or any other wearable electronic device that can be used to uniquely identify and track the location. The reception and transmission of data is carried out through a mobile communication network, a data network Wi-Fi or 3G/4G/5G. In order to evaluate the effectiveness of the displayed information, a conversion rate of an offline audience into an online audience is determined.

The consumer profile containing information about advertising preferences of consumers is obtained by sending a request and receiving a response from a database of consumer preferences and third-party services for providing information about consumers, while the profile contains data on the registration of mobile devices of users in social networks, wi-fi, the Internet and other networks; information displayed to consumers on the Internet associated with mobile device identifiers. The consumer profile contains information about age, gender, race, place of birth, marital status, information about friends and family.

In order to assess the effectiveness of the displayed content or information display means, the number of consumers located near the information display means during the demonstration of specific content or content relevant to them is determined, and the number of consumers located near the means display information for a certain period of time, receive data on the budget of the advertising campaign with the subsequent determination of the cost of an audience unit for specific content. In order to assess the effectiveness of the displayed content, the number of consumers located near the information display means during the display of specific content and the number of impressions of this content are determined, data on the budget of the advertising campaign are obtained, followed by determining the cost of one consumer contact with a specific content by dividing the specified budget of the advertising campaign by the number of consumers who were near the means of displaying information in time when specific content is displayed and the number of impressions a specific content.

The CPM cost and CPT cost are determined by dividing the cost of one impression and the cost of one consumer contact with a specific content by 1000. In order to assess the effectiveness of the displayed content, the proportion of the audience reached is determined by dividing the number of consumers who were near the information display means while displaying specific content by the total number of consumers who were near all information display means and display means information located in a specific area and specific locality and in a specific region. To determine the cost of posting content on a means of displaying information by the proportion of the audience and by the number of consumers who were near the means of displaying information and by the number of consumers who were near the means of displaying information during the display of specific content and by the number of unique consumers who were near the means of displaying information while displaying content relevant to them and by the number of contacts.

An advantage of the present invention is to provide the innovative system, method, and computer-readable medium using thermal camera, additional sensors a module allowing to receive real time accurate human body temperature data in overcrowded spaces with different background thermal reflections.

The objects and advantages of the present invention will be more readily apparent from inspection of the following specification, taken in connection with the accompanying drawing, wherein like numerals refer to like parts throughout and in which an embodiment of the present invention is described and illustrated.

The exact manner in which the foregoing and other objects and advantages of the invention are achieved in practice will become more clearly apparent when reference is made to the following detailed description of the preferred embodiments of the invention described in detail in the following specification and shown in the accompanying drawings, where in like reference numbers indicate corresponding parts throughout.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 illustrates a schematic view of a method for managing advertising and information content intended for placing on the means of displaying information, with the possibility of evaluating the effectiveness of the displayed content; and

FIG. 2 illustrates a schematic view of an algorithm outlining the method for managing advertising and information content intended for placing on the means of displaying information, with the possibility of evaluating the effectiveness of the displayed content.

### DETAILED DESCRIPTION OF THE INVENTION

Referring to the Figures, a system, a method, and a non-transitory processor-readable medium, i.e. a computer readable medium (the system) is used to screen, track and trace human body temperature, are shown. Because explicit identification of object-oriented constructs expressed through the syntax of high-level object-oriented programming languages is lost during compilation to binary code (e.g., translation of a source code definition or representation of an application to a binary code definition or representation of the application such as a machine code or byte-code definition), potential security vulnerabilities can be obscured during static analysis of the resulting binary code.

For example, because information about an object (e.g., the class on which the object is based, the size of the object, the number and types or sizes of properties of the object, and the number of functionalities accessible to the object via a dispatch table) is typically not expressed in binary code, determining whether indirect operations relative to the object expose security vulnerabilities can be difficult without the source code from which the binary code was generated.

As a specific example, an indirect operation can result in arbitrary code execution security vulnerabilities if the binary code does not include run-time validation to ensure that the indirect operation does not operate outside or beyond the object (i.e., at memory addresses not allocated to or shared by the object). Some binary code representations of applications, however, do include information about objects. Such information can be included in binary code as run-time type information (RTTI) or debugging information that is compiled into the binary code. Nevertheless, because the binary code representations of many applications do not include such information (e.g., to discourage reverse engineering of these applications), robust methodologies and systems for analyzing binary code based on (or derived from) source code using object-oriented techniques should not assume availability of such information.

Implementations discussed herein analyze operations described in binary code to identify objects based on those operations. Said differently, implementations discussed herein reconstruct, at least partially, objects (or representations of objects) by inferring the structure of such objects based on operations described in binary code. Thus, implementations discussed herein can identify objects and attributes such as a size thereof without referring to (or independent of) source code or explicit information about such objects which may or may not be included in the binary code.

Furthermore, implementations discussed herein perform security vulnerability analyses of binary code representations of applications using such objects. For example, implementations discussed herein can identify security vulnerabilities such as type confusion vulnerabilities that can result in arbitrary code execution, code injection, application failure, or other undesirable or unintended behavior of an application using information about objects identified by analysis of operations described in binary code.

Accordingly, implementations discussed herein with reference to analysis of operations described in binary code should be understood to refer to analysis of those operations using a binary code representation of a software module or a representation of the software module derived from the binary code representation.

A variable within a memory is a memory location at which one or more values can be stored. Such a memory location can be at a processor memory (e.g., a register or cache), at a system memory (e.g., a Random Access Memory (RAM) of a computing system), or at some other memory. Operations within binary code that operate on such variables can refer to a memory address (either absolute or relative to another memory address such as an offset from a stack pointer) of that memory location. Thus, the identifier (e.g., memory address) of an object can be stored as a value at a memory location with a memory address that is used by operations within the binary code.

Accordingly, as used herein, terms such as “identifier of an object” and “memory address of an object” should be understood to refer to the identifier (e.g., memory address) itself or to a variable at which a value representing the identifier is stored. As used herein, the term “module” refers to a combination of hardware (e.g., a processor such as an integrated circuit or other circuitry) and software (e.g., machine- or processor-executable instructions, commands, or code such as firmware, programming, or object code).

A combination of hardware and software includes hardware only (i.e., a hardware element with no software elements), software hosted at hardware (e.g., software that is stored at a memory and executed or interpreted at a processor), or at hardware and software hosted at hardware.

Additionally, as used herein, the singular forms “a,” “an,” and “the” include plural referents unless the context clearly dictates otherwise. Thus, for example, the term “module” is intended to mean one or more modules or a combination of modules. Furthermore, as used herein, the term “based on” includes based at least in part on. Thus, a feature that is described as based on some cause, can be based only on that cause, or based on that cause and on one or more other causes.

It will be apparent that multiple embodiments of this disclosure may be practiced without some or all of these specific details. In other instances, well-known process operations have not been described in detail in order not to unnecessarily obscure the present embodiments. The following description of embodiments includes references to the accompanying drawing. The drawing shows illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical and operational changes can be made without departing from the scope of what is claimed. The following detailed description is, therefore, not to be taken in a limiting sense, and the scope is defined by the appended claims and their equivalents.

Alluding to the above, for purposes of this patent document, the terms “or” and “and” shall mean “and/or” unless stated otherwise or clearly intended otherwise by the context of their use. The term “a” shall mean “one or more” unless stated otherwise or where the use of “one or more” is clearly inappropriate. The terms “comprise,” “comprising,” “include,” and “including” are interchangeable and not intended to be limiting. For example, the term “including” shall be interpreted to mean “including, but not limited to.”

The technical result is the provision of objective and reliable information about the target audience for the demonstration of advertising and information content, which allows you to objectively evaluate the effectiveness and efficiency of advertising campaigns and dynamically select and play advertising and informational announcements in accordance with the profile of the potential consumer, including through the use of a set of parameters characterizing the target consumers, including the true unique identifiers of their mobile computing devices, as well as through the use of the results of the analysis of the interaction of consumers with a means of displaying information.

The technical result is achieved through the development of a method for managing advertising and information content intended for placement on a means of displaying information, with the ability to evaluate the effectiveness of the displayed content, including: obtaining data on the unique identifiers of mobile devices of potential content consumers located in the area of placement of at least one means of displaying information, with the formation of the corresponding identifier database, obtaining consumer profile data corresponding to the obtained unique identifiers containing at least one type of information from the following list: demographic characteristics, payment history, browsing history, shopping habits, income, advertising preferences, types and characteristics of consumer's mobile devices, movement routes, time spent in the content visibility zone, repeatability of routes, with the formation of the corresponding database of profiles, obtaining data on the content displayed on the information display means with the formation of the content database; establishing the connection of each identifier of a mobile device from the identifier database with the corresponding content of the information display means and the consumer profile from the respective databases, statistical analysis of the established relationships of identifiers to determine at least one criterion from the following list: the number of consumers who were near the display medium at various points in time, the number of target consumers who were near the display medium during the display of relevant content for them, total the number of consumers and/or target consumers who were near all the means of displaying information and/or means of displaying information located in the region and/or a particular locality and/or in a particular region, the number of impressions during finding content user about information display means, content management based on the results of a statistical analysis with the possibility of evaluating its effectiveness, in order to obtain data on unique identifiers of consumer's mobile devices located in the area of displaying information display devices, at least one device for receiving and analyzing signals from consumer's mobile devices is placed on each display means, the true identifiers of mobile devices are determined using this device consumers located in the coverage area (location area) of the device, register the time of signal reception from the mobile device and the corresponding unique identifier signal receiving location (identifier information display means), to obtain data on the consumer profile containing information about travel routes, travel time, route repeatability, determine the location, direction of movement and speed of movement of the consumer's mobile device relative to the information display means based on the recorded values of the signal reception time from each mobile device and unique location identifiers signal reception, to obtain data on the content displayed on the information display means and to establish its connection with the unique identifier of the consumer's mobile device, the time interval for the mobile device to be located near the information display means is determined and correlated with the data on the content of the displayed information and the exact time the information was displayed, at the same time, to determine the true unique identifiers of mobile devices of consumers, they filter out randomized identifiers of mobile devices of consumers, including reading requests from a mobile device of a consumer by a device for receiving and analyzing signals, and then extracting data from requests received for a certain time interval and comparing the extracted data from all requests received for a certain time interval, and the exclusion of requests with different identifiers m abundant devices and repeating data.

The MAC address, IP address, TCP port number, or any other identifier is used as a unique identifier for mobile devices. When using a MAC address as a unique identifier for mobile devices, Probe Request requests are used as requests from mobile devices of consumers, and data from WLAN Management data frames is used as data extracted from requests from a consumer's mobile device. As a device for receiving and analyzing signals from mobile devices of consumers, they use a Wi-Fi radar or Wi-Fi scanner or Wi-Fi sniffer configured to work in the scanning mode of mobile devices of consumers. As a device for receiving and analyzing signals from mobile devices of consumers, devices with a MAC address de-randomization algorithm are used, which allow receiving true MAC addresses of consumers' mobile devices.

When filtering randomized MAC addresses, a certain time interval is selected in accordance with the average time spent by the consumer's mobile device in the range of the device for receiving and analyzing signals. To obtain data on unique identifiers of mobile devices of consumers, registration of sample request frames sent by mobile devices of consumers is carried out. Additionally, video data can be obtained from the location area of the information display means. In this case, the video data is obtained using at least one video camera installed on or near the information display means, which determine the number of consumers in the surveillance area of the video camera for a certain period of time, and/or evaluate the directions of the consumers' gaze and/or recognize emotions consumer, the data obtained is used for subsequent statistical analysis and evaluation of the effectiveness of the displayed information.

Based on the assessment of the direction of the gaze of consumers, an exception is made from the statistical analysis of random identifiers of mobile devices of consumers who did not interact with the means of displaying advertising information. The consumer's mobile device is a smartphone, personal digital assistant (PDA), tablet computer, smartwatch, or any other wearable electronic device that can be used to uniquely identify and track your location. Data reception and transmission is carried out through a mobile communication network, a Wi-Fi or 3G/4G/5G data transmission network. To evaluate the effectiveness of the displayed information, the conversion rate of an offline audience into an online audience is determined.

When implementing the method, visualization of the data obtained as a result of statistical analysis in graphical and/or digital form can be carried out. In this case, advertisers can access the data of statistical analysis. As part of the implementation of the method, the selection and transmission of content of interest to one consumer or group of consumers for display on the information display means can be made. A consumer profile containing information about advertising preferences of consumers can be obtained by sending a request and receiving a response from a database of consumer preferences and/or third-party services for providing information about consumers, while the profile contains data on the registration of users' mobile devices in social networks, wi-fi, Internet and other networks; Information displayed to consumers on the Internet associated with mobile device identifiers.

A consumer profile may contain information about age, gender, race, place of birth, marital status, information about friends and family, as well as other characteristics defined by the user or collected by the wireless provider. As part of the implementation of the method, continuous or periodic updating of these consumer profiles can be carried out. To assess the effectiveness of the displayed content and/or information display means, the number of consumers who were near the information display means during the demonstration of specific content or content relevant to them was determined, and/or the number of consumers who were near the information display means for a certain period of time receive data about the budget of the advertising campaign with the subsequent determination of the cost of an audience unit of specific content and/or the cost of an audience unit of funds from expressions information by dividing a predetermined budget to the corresponding number of consumers.

To assess the effectiveness of the displayed content, the number of consumers who were near the means of displaying information during the display of specific content and the number of displays of this content are determined, data on the budget of the advertising campaign are obtained, followed by determining the cost of one consumer contact with specific content by dividing the specified budget of the advertising campaign by the number of consumers located near the means of displaying information during the display of specific content and on The number of impressions for a specific content.

Cost per thousand impressions (CPM) and/or cost per thousand contacts (CPT) can also be determined by dividing the cost of one impression and/or the cost of one consumer contact with a specific content by 1000. To assess the effectiveness of the displayed content, the share of the covered audience is determined by dividing the number of consumers who were near the information display means while displaying specific content by the total number of consumers who were near all information display means and/or information display means located in a specific area and/or a specific locality and/or in a specific region.

The cost of posting content on an information display means can be determined by the proportion of the audience covered and/or by the number of consumers who were near the information display means and/or by the number of consumers who were near the information display means during the display of specific content and/or by the number of unique consumers located near the means of displaying information during the display of content relevant to them and/or by the number of consumer contacts with a particular content or content relevant to them.

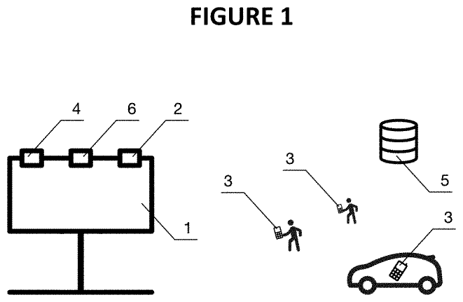

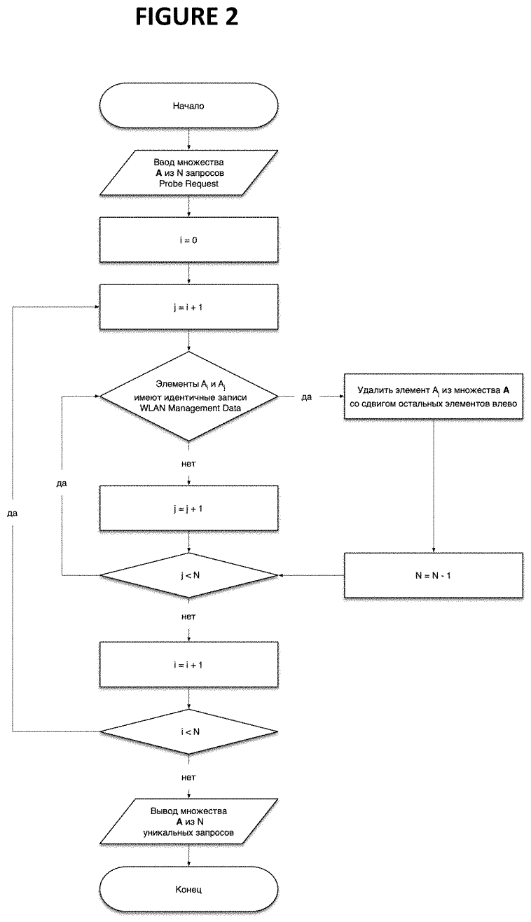

An auction can be held among customers through a competition in which the unit price for one consumer (audience unit) and/or one contact and/or CPM and/or CPT and/or for the share of the audience reached is determined and the cost of content placement is determined based on the unit price. The proposed solution provides the identification of the true MAC address of the device and verification of counting data by identifiers of mobile devices with data obtained using a video camera. The invention is illustrated by illustration and block diagram, where FIG. 1 shows an example implementation of the method of the present invention and FIG. 2 is a block diagram of a de-randomization algorithm of the present invention. Referring now to FIG. 1, means of displaying information are shown at 1, a device for receiving and analyzing signals from mobile devices is shown at 2, a mobile consumer device is shown at 3, a computing module is shown at 4, a data processing server is shown at 5, and a video camera is shown at 6. It should be noted that the above FIGS. 1 and 2 are given by way of illustration, and do not limit the subject of the present invention to individual embodiments of the present technical solution.

These implementations are described in sufficient detail so that experts in the field of technology can put into practice a technical solution, and it should be understood that various implementations can be created and/or replacements of various elements can be made without going beyond the scope and essence of this technical solution. In addition, various embodiments of the described technical solution can be implemented in the form of software running on a general purpose computer, in the form of specialized hardware or a combination of software and hardware.

Referring now to FIG. 1, at least one device 2 is placed on the information display means 1 for receiving and analyzing signals from the mobile devices 3 of the consumers and by means of this device identifiers of the mobile devices of the consumers located in the coverage area (area of location) of the device 2 are determined. In this case, the signal reception time from of each of the mobile device 2 (points in time at which unique identifiers of mobile devices of users were determined) and its corresponding unique identifier signal receiving position (identifier of the information display means). In this case, the information display means may be provided with the computing module 4, which determines the time of reception of the signal from each mobile device 2 and the corresponding unique identifier of the location of signal reception.

The received data (unique identifier of the mobile device, location identifier of the signal reception, time of signal reception) is transmitted to the data processing server 5 (for example, by means of a computing module equipped with communication means). On the server (or in the computing module), data is calculated including the location, direction of movement and speed of movement of the mobile device relative to the information display means based on the recorded values of the signal reception time by the device 2. Based on the received data, the time interval for the mobile device to be in the range of the device 2 is determined. For each identifier of the mobile device 2, the time interval of the consumer's mobile device being in the valid area is stored.

In the device 2, and data on the content (display information) on the vehicle 1 during the time interval of the mobile device being in the scope unit 2, and the exact time display. Moreover, data on the content of the displayed information can be obtained from the means of information display and/or from the software that controls the display of information on means 1. For the number of means of information display at least two, determine travel routes, travel time, repeatability of routes, geographical preferences consumer.

From external data sources receive information about the profile of consumers: data on the registration of users' mobile devices in social networks, wi-fi, the Internet and other networks; consumer preferences associated with mobile device identifiers; about information shown to consumers on the Internet, types of advertising and/or information materials corresponding to identifiers of mobile devices, etc. Then, each identifier of the mobile device from the set of identifiers is associated with the content of the means for displaying advertising information and consumer profiles, and a statistical analysis of the associated identifiers is performed to evaluate the effectiveness of the displayed advertising/information content, for example, based on determining the conversion of an offline audience to an online audience, as well as the number of consumers located in the coverage area of the device 2 during the broadcast of the relevant data (for use of the data, e.g., number of impressions for sale).

Based on the duration of the “advertising contact” of the consumer/target consumer with the means of displaying information, the cost of displaying the content can be determined, and the fee can be charged only for contact with a given target audience of the advertiser. In addition, based on the results of statistical analysis, targeted display of advertising information (individual communication) can be carried out.

Data for analysis can also be obtained in accordance with the method described in Russian Federation Patent No. 2640441, which allows to accumulate data on consumer behavior. Based on a statistical analysis of the associated identifiers, the value of the audience unit of the information display device and/or the audience unit covered by the displayed content can be estimated by dividing the predetermined advertising campaign budget by the number of consumers who were in the coverage area of the device 2 while displaying specific content and/or relevant for them information. The cost of one consumer contact with a particular information displayed can also be estimated by dividing a predetermined budget by the number of consumers who are in the coverage area of the device for receiving and analyzing signals while displaying specific information displayed and by the number of demonstrations of specific information displayed; CPM and/or CPT indicators are determined by dividing the cost of one consumer contact by 1000; determined the proportion of the audience by dividing the number of consumers who were in the coverage area of the device 2 during the display of specific displayed information by the total number of consumers who were in the coverage areas of the devices 2 of all information display devices and/or information display devices located in a specific village and/or in a specific region. Based on the results of the analysis, if necessary, they determine the cost of advertising by the share of the audience covered, or by the number of unique consumers who are in the coverage area of the device 2 or located in the coverage area of the device 2 while displaying specific information, and also conduct an auction among customers by competition in which they determine the unit price for one consumer, or one contact, or CPM, or CPT, or for the proportion of the audience covered, and on the basis of the unit price determine the cost of information.

The information display device 1 may be an electronic display device, such as digital signage, allowing dynamic selection and playback of advertisements, for example, liquid crystal displays, LED displays, plasma displays, projected displays for displaying multimedia content in public places (wall panels, billboards, multi-vision installations, multimedia facades, digital billboards, digital supersites). In this case, the display device can be placed on racks, poles or other stationary structures, inside or outside buildings, as well as outdoors—on the streets, along roads, on any moving objects, in particular in and/or on the back of a car, bus, trolley, tram, trains, aircraft, trains, as well as in the subway, at railway, bus stations and platforms.

As a consumer's mobile device 3, this invention is understood to mean any mobile computing device to which a consumer (user) usually has constant access. Such a mobile computing device includes mobile communications (mobile phone—a regular cell phone or smartphone), personal digital assistant (PDA), tablet computer (wireless, connected to a data network using, for example, Wi-Fi, WiMax or cellular transmission data), “smart watches”, etc. In this case, in a preferred embodiment of the invention, the mobile computing device includes a smartphone or any other wearable electronic device that can be used for a unique track the location of a person in a monitored environment. In a particular embodiment of the invention, software applications (“applications”) running on a mobile computing device that communicate with one or a plurality of the devices 2 to receive and analyze signals from mobile devices in a monitored environment can be installed on a user's mobile computing device.

The MAC address, IP address, TCP port number, or any other identifier can be used as a unique identifier for mobile devices. In a preferred embodiment, the unique identifiers are the MAC addresses (media access control) of the mobile devices. In the case of IEEE 802 compliant networks (such as Ethernet), DLC protocol addresses (DLC addresses) are usually referred to as MAC protocol addresses (MAC addresses). In order to be defined as a DLC protocol address, the address must satisfy at least the OSI reference model (Open Systems Interconnection) of the ISO standards. The OSI reference model defines a 7-tier structure for implementing network protocols. In other words, the DLC address or MAC address, respectively, is a hardware address that uniquely identifies a node or a physical network interface in a network. Some protocols, such as Ethernet or Token Ring, use only the DLC/MAC address, that is, they cannot communicate with the corresponding node without this address.

The device 2 provides reception and analysis of a signal (wireless message) from a user's mobile device by extracting a MAC address from a message sent from a wireless mobile device in accordance with the wireless data transmission protocol. Moreover, as the device 2 for receiving and analyzing signals from mobile devices of consumers, a Wi-Fi radar or a Wi-Fi scanner configured to work in the scanning mode of mobile devices of consumers is used. The principle of operation of a Wi-Fi radar or Wi-Fi scanner is based on the interaction of mobile devices with Wi-Fi access points. Smartphones, tablets and other mobile devices of the user send requests for connection to Wi-Fi networks every 3-5 seconds. A radar or scanner registers these requests (sample request frames) and reads the MAC address contained in them—a unique identifier for the corresponding network device.

Thus, information about each mobile device with the Wi-Fi module turned on, located within a radius of 100-150 meters from the Wi-Fi radar, falls into the cloud database. At the same time, mobile devices do not need to connect to a Wi-Fi network—the MAC address is scanned in the background while the mobile device is in the pocket or bag of a potential consumer passing or passing by an information display device. Thus, the device 2 allows you to automatically register any phone that is within the Wi-Fi range, and receive information from it about the MAC address of the device, as well as the time of reception and power of the received signal. The data obtained are then used to analyze the consumer audience. A feature of the present invention is the use of the algorithm of “de-randomization” of MAC addresses, which allows, on the one hand, to exclude from the analysis many generated MAC addresses of the same device, and on the other hand, to obtain it from a mobile device (phone, tablet, etc.) true MAC address.

This allows you to verify the origin of the received data from a specific device and from a specific user (allows you to link the user identity and the identifier of the mobile device). A method for filtering the randomized MAC addresses of mobile devices of consumers within the framework of the invention is as follows. When a consumer with a mobile device enters the zone of location of information display devices equipped with the devices 2, i.e. at least one Wi-Fi scanner or radar of at least one information display device in the area of which the consumer is located in the coverage (action) area of Wi-Fi scanners or radars reads the sample request frames mentioned above (Probe Request) sent by the consumer's mobile device, which determines the location of the consumer with the mobile device in the coverage area of the device 2.

The device 2 transmits the read Probe Request requests to the computing module. The computing module collects all Probe Request requests received for a certain time interval (for example, in the last 10 seconds of data collection) and processes them: extracting data from WLAN Management data frames in Probe Request requests; comparing selected data from all Probe Request requests received for a certain time interval and excluding requests with different MAC addresses and repeating WLAN Management Data. MAC addresses contained in non-excluded requests are considered to be true identifiers of consumer mobile devices. Moreover, a certain time interval is selected in accordance with the average time spent by the consumer's mobile device in the range of the device for receiving and analyzing signals.

Data on identified identifiers of mobile devices of consumers is sent by means of a computing module to a server for processing and/or storage. Request analysis Probe Request can be carried out directly on the server without sending requests to the computing module. This method allows you to exclude from the statistics deliberately random identifiers of mobile devices. In addition to Probe Request requests, Association Request requests can also be collected. A device for receiving and analyzing signals from mobile devices (Wi-Fi—scanner or radar) of consumers can be implemented in the form of any compact computer device with a Wi-Fi wireless network connection interface that supports the Monitor Mode (a standard mode that allows reading all traffic in a wireless communication channel without connecting to an access point or peer-to-peer network). At the same time, in order to derandomize identifiers of mobile devices, a Wi-Fi scanner or radar must support the following network standards: IEEE 802.11a; IEEE 802.11b; IEEE 802.11g; IEEE 802.11n; and IEEE 802.11ac. In one embodiment, to identify the true MAC address, at least two receiving devices (Wi-Fi sniffers) are placed along the passenger flow at a distance of 20-50 m from each other. At the same time, sniffers can be installed not only on the means of information display—displays and billboards, but also on any other stationary surfaces (poles, building facades, etc.).

If the same MAC address has got to both the first sniffer and the second sniffer, then a conclusion is made that the identifier is highly likely (not randomized) to be real. At the same time, data on the received signal power is used to filter the Probe Request. When receiving any data, the WiFi sniffer module measures the level of the received signal in the form rssi (dbm): setting a limit on a certain rssi value, you can control that data with a signal level greater than a specified threshold will be processed. This eliminates the possibility of receiving the same signal (i.e. the same Probe Request frame) simultaneously by two sniffers. Therefore, the successive reception by two sniffers of Probe Request frames containing the same MAC address corresponds to a situation in which the mobile device uses the same MAC address in all requests and this MAC address can be considered true for this mobile device. Data processing from requests from mobile devices can be carried out centrally, while data from all sniffers are transmitted and processed on a cloud server. It is worth noting that the said sample request frames are sent by the consumer's mobile device at the interval specified by the mobile device manufacturer.

In this particular case, the unique identifier (MAC address) of the consumer's mobile device is also read with a predetermined frequency (for example, once every 10 seconds) to track the presence of a mobile device in the coverage area of the Wi-Fi scanner. In a particular embodiment of the invention, in addition to the device 2, the information display means may be provided with at least one video camera 6. Using the video camera, video information is obtained in the area located near the information display means. Information from the video camera also enters the computing module 4 (or directly to the data processing server) connected to the video camera, which is configured to process the video information received from the video camera and determine the number of cars and/or people who are in the video camera's observation area for a certain period of time, as well as highlighting (recognizing) faces and evaluating the direction of a person's gaze.

The camcorder can be represented by a webcam or any other device recording a video stream. The data received by the computing module is transmitted to the data processing server, where it can be used (for example, in the computing module) to exclude from the processing (analysis) random MAC addresses of mobile devices of consumers located near the information display tool but not interacting with it (for example, who haven't watched the advertising content displayed on the billboard).

The data from the video camera can also be used for realizing the recognition of consumer emotions in real time when viewing the displayed content, identifying individual personality characteristics, which can contribute to more accurate prediction of consumer interests, understanding what, in what form, how many times and when this consumer can effectively target advertising. At the same time, methods known from the prior art that provide high recognition rates can be used to recognize faces and emotions, for example, by analyzing a 3D model of a face, by automatically recognizing an artificial neural network using pre-prepared data sets (Cohn-Kanade (SK+), MMI facial expression database, Toronto facial dataset (TFD), etc.) using hidden Markov models, Bayesian networks, and other methods. The use of true identifiers of mobile devices in combination with video camera data allows us to more accurately segment consumers and determine how potential consumers correspond to the target segment, which provides the most objective and reliable results of content marketing analysis that can help, in particular, advertisers in deciding on advertising content, in terms of the cost of advertising, products and services, etc.

The information obtained by the computing module can be stored on a local storage medium or transmitted via communication channels (for example, the Internet) to a data processing server. At the same time, data on unique identifiers of mobile devices and other calculated data can be transmitted via a mobile communication network, for example, a Wi-Fi or 3G/4G/5G data network. The data processing server 5 generates data sets that are stored on the server in the form of various databases. In particular, the server accumulates and stores data received from the computing module (or directly from a Wi-Fi scanner or radar) about the unique identifiers of mobile devices of consumers located in the area of displaying advertising information, their duration in the field of displaying advertising information, and associated identifiers of means for displaying advertising information; a database of content displayed on the means of displaying advertising information and time display content.

The server may comprise or is configured to provide external access to consumer profile databases corresponding to identifiers of mobile devices, including a set of characteristics of the end user of a mobile device, such as, for example, age, gender, race, place of birth, payment history, history of viewing content, shopping habits (for example, viewing or buying certain goods and services), information about friends and family, information about the types and characteristics of consumer's mobile devices, x unique identifiers, etc. Said data can be obtained from open data from social networks, from a wireless provider, when a user activates an account in a wireless network. It should be noted that information related to the end user is compiled and transmitted to the server without any indication of the user's identity, while the server can be implemented with secure access control that prevents unauthorized access to databases located on the server.

The database of the consumer profile corresponding to the unique identifier also includes data on consumer travel routes, travel time, route repeatability, geographic preferences of consumers. The data described above can be stored as one or more database tables containing database records. Moreover, for the management, creation and use of databases can be used in various database management systems known from the prior art. The server may contain an analytics module that associates (establishes connections—correspondences) each identifier of a mobile device from a variety of identifiers with the content of the means for displaying advertising information and consumer profiles, as well as a statistical analysis of the associated identifiers to evaluate the effectiveness of the displayed advertising information.

Moreover, correspondences can be established by one of the mathematical methods, in particular, by using diagrams, which allow, for example, creating correspondences between two sets of points on the X and Y plane, where each point is from the set Y (for example, the identifier of a mobile device with the corresponding identifier of the time of reception of the signal from this mobile device) is mapped to a point from the set X (for example, the content displayed on the information display means during reception and the signal from the mobile device). The data processing server can be equipped with a user interface that allows you to visualize (display) the data processed on the server (statistical data), as well as data obtained as a result of analysis after establishing compliance. Visualization can be implemented in graphical and/or digital form, convenient for viewing. In this case, the advertiser can act as the user of the interface, access to the interface can be organized through the advertiser's personal account.

The computing module can be implemented both on the information display tool (built-in to the tool 1) and on a remote data processing server. The server includes a microprocessor that executes software instructions. The microprocessor is associated with a storage medium containing databases, with information about the consumer profile and advertising content, as well as software instructions that the microprocessor performs.

Devices (modules) and/or their components described within the framework of this technical solution can be connected to each other via wired and/or wireless means/methods of communication, as well as through various types of connections, including detachable or one-piece (for example, through terminals, contacts, adapters, soldering, mechanical connections, etc.). Communication tools can be implemented, for example, through local area networks (LAN), a USB interface, an RS-232 standard interface, Bluetooth, Wi-Fi interfaces, the Internet, and mobile cellular (GSM). Data transfer between modules and devices of this technical solution can be carried out using HTTP, HTTPS, FTP, TCP/IP, etc. protocols, including through protocols, IEEE 802.15.4 and ZigBee standards, including APS and NWK using services lower layers, MAC access control layer and PHY physical layer and others.

The present invention was adapted to solve the problem of broadcasting and managing information content on the example of information display devices—digital displays intended for installation on subway station platforms. The system that implements the proposed method included a data processing server, at least one consumer mobile device, at least one information display means—an advertising digital display equipped with a Wi-Fi sniffer, a video camera and a computing module installed in a single housing. At the same time, the metro stations were also equipped with server equipment with preinstalled software (software) for the unified management and storage of content (display management), as well as network and auxiliary equipment for organizing network communications.

The computing module was implemented on the basis of a processor with the Android operating system (version no lower than 4.4), with a base clock frequency of at least 2.6 GHz, the number of threads—at least 4, slots for memory modules—at least 2 SODIMM, with memory at least 8 GB (cache of at least 3 MB), SSD disk—at least 64 GB. As a Wi-Fi sniffer, a device was used that has the following characteristics: the maximum wireless data transfer speed of a Wi-Fi sniffer is at least 867 Mbps, the supported frequencies are 2.4 GHz and 5 GHz (the ability to work simultaneously on 2 frequencies), support for 802.3 at PoE, the presence of at least 1 IEEE 802.3ab standard, the presence of spatial coding DSSS, OFDM, MIMO, the maximum throughput of each IEEE 802.3ab port is at least 1 Gb/s, the presence of built-in antennas (with a coefficient gain of at least 3 dBi at 2.4 GG; at least 5 Bi at 5 GHz) output power: not less than 2.4 GHzBand: 23 dBm, is not less than 5 GHzBand: 23 dBm, BLE not less than 3 dBm, the availability of system memory at least 1 GB.

As a video camera, we used a 3D camera with an infrared stereo projector, with an RGB sensor resolution and a frame rate of at least 1920×1080, with a maximum range of at least 10 m, an output resolution of 3D data of at least 1280×720, and a maximum frame rate of output 3D—stream—not less than 90 frames/sec. The server included at least two processors with power supplies and information panels, with installed RAM of at least 64 GB, a base clock frequency of at least 2.40 GHz with support for NVDIMM memory modules, a base clock frequency of memory modules of at least 2666 MHz, s support for SAS and SATA, NVMe, SmartPatch, SmartCache.

The system provided the following functions: display of information on digital displays to inform passengers (in various formats of video and audio), incl. Scheduled broadcast of media content, taking into account its address translation; recording and storage of the broadcast content of each digital display with the possibility of battery life for several days; creation of personal accounts for advertisers, accounting for broadcasting (in case of failures in broadcasting information/advertising content on digital displays—automatic adjustment of playlists), informing advertisers about the time of broadcasting information/advertising media content; integration with external systems; collection of MAC addresses, their transmission and processing with the possibility of de-randomization; video analytics of television viewing of information/advertising content with the division of watching by age and gender.

The digital display software provided playback of static and dynamic media content, counting the number of contacts in front of the display, and collecting statistical information about the displayed content (broadcast on the displays) installed at subway stations. The digital display software interacted with the digital display management software when performing functions: periodically sent requests for new commands from the server; execute commands if the server returns a new command; sent the execution results (standard console output) to the server. To count the number of contacts, the digital display software performed the following functions: the background process of working with the display camera, using the face recognition algorithm, sufficient to fix the number of faces in the frame; counting and transmitting at the request of the server an assessment of the age and gender of the person; estimates of the time of watching; the total number of persons currently in front of the display (contacts); regular calculation and saving of parameters according to the number of contacts listed above, with a set frequency; receiving data from a Wi-Fi sniffer; sending collected data on the number of contacts in JSON format to the server with the above parameters.

To generate and send statistics data, the software performed the following functions: generation of statistics with the following parameters: start time for video playback; GPS reference coordinates (latitude/longitude); campaign and content identifier; saving statistics data to the display database; evaluation and counting of un played videos and their time, counting the number of repetitions of each video for the period; sending statistics in JSON format to the server with the above parameters and versions of the software and hardware platform. The digital display management software (server) interacted to ensure the transmission and broadcast of media content on screens with digital display software and an information and advertising service (IRS).

When interacting with digital display software, the management software provided control of all processes occurring on the screen, except for playlist playback and automatic collection of statistics and technical monitoring data. When interacting with IRS, the management software performed the functions of remote management and data exchange in the processes: registration of digital displays; authorization of digital displays; downloading and transfer of media content that has passed moderation; transmission of digital display control commands; transfer of statistics files and technical monitoring. To receive display statistics files from displays, the management software performed the following functions: receiving requests from digital display software with statistics files, including data on the number of contacts when displaying a media file; transmitting statistics showing media content in the IRS.

For the interaction between the server and client devices, the WebSocket protocol (or similar) was used. Using the above-described system, the number of contacts of target consumers with media content periodically displayed on a digital display for a month was determined, based on which the effectiveness of the advertiser's advertising campaign was evaluated and the cost of placing media content was calculated. Among the target consumers were selected including males who had shopping habits in the field of equipment for hunting or fishing. The use of the de-randomization algorithm in determining the identifiers of mobile devices of consumers located near the digital display, as well as the use of data obtained from the video camera, made it possible to obtain an objective and more accurate assessment of the effectiveness of the advertising campaign.

The various sequences of operations described above may be performed by program instructions executed by at least one processor and/or integrated circuits (ASICs). In addition, the sequence of actions can be fully implemented in any form of computer-readable storage medium, so that the execution of the sequence of actions allows the processor to perform the functions described in this document.

It should be noted that the above figures are given by way of illustration, and do not limit the subject of the present invention to individual embodiments of the present technical solution. These implementations are described in sufficient detail so that experts in the field of technology can put into practice a technical solution, and it should be understood that various implementations can be created and/or replacements of various elements can be made without going beyond the scope and essence of this technical solution. In addition, various embodiments of the described technical solution can be implemented in the form of software running on a general purpose computer, in the form of specialized hardware or a combination of software and hardware.

As it is currently done in the industry, a business that offers goods or services hires a creative and marketing agency that generates a content and also hires a media agency that received the creative content and creates a marketing campaign. The information is then submitted to the company that owns outdoor or indoor structures where advertising of the goods and services provided by the business is displayed. People watch the advertising and then if they desire, they contact the business to purchase the goods and services. In this aforementioned prior art situation, all parties win and benefit financially except targeted audience.

In alternative embodiment of the present invention, a new improved cash back and loyalty application is offered. The business that offers goods or services will be equipped with a smart box at any location of the business that sells goods and/or services. The smart box will be operably communicated with a smartcome module that will retain various personal data received and stored from the targeted audience and grouped by age, gender, race, geographic location, etc. The companies that owns outdoor or indoor structures where advertising of the goods and services provided by the business will also be equipped with the smart boxes. A person who will see the advertisement about certain product and will go to purchase that product and/or the service from the business will receive cash bonuses or other incentives from the companies that owns outdoor or indoor structures and from the business that sells the products and services. In addition, the smartcome module will receive funds from the business for sharing the information of targeted audience.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for managing advertising and information content for placement on an information display means, with the ability to evaluate the effectiveness of the displayed content and/or information display means, said method including the steps of:
obtaining data on the unique identifiers of mobile devices of potential content consumers located in the area of placement of at least one information display means, with the formation of the corresponding identifier database;
obtaining consumer profile data corresponding to the obtained unique identifiers containing at least one type of information from the following list: demographic characteristics, payment history, browsing history, shopping habits, income, advertising preferences, types and characteristics of consumer's mobile devices, routes movement, time spent in the content visibility zone, repeatability of routes, with the formation of the corresponding database of profiles;
obtaining data on the content displayed on the information display means with the formation of the content database;
establishing a connection of each identifier of a mobile device from the identifier database with the corresponding content of the information display means and the consumer profile from the corresponding databases;
analysis of the established relationships of identifiers to determine at least one criterion from the following list: the number of consumers who were near the means of display at various points in time, the number of target consumers who were near the means of displaying information while displaying content relevant to them, the total number of consumers and/or target consumers located near all information display facilities and/or information display facilities located in a specific area and/or particular locality and/or in a particular region, the number of impressions during finding content user about information display means;
content management based on the results of the analysis with the possibility of evaluating its effectiveness;
in order to obtain data about unique identifiers of mobile devices of consumers located in the area of displaying information display devices, at least one device for receiving and analyzing signals from consumer mobile devices is placed on each information display means, true identifiers of mobile devices are determined by this device consumers located in the coverage area of the device, while registering the time of reception of the signal from each mobile device roystva and its corresponding unique location identifier of the reception signal,
to obtain data on the consumer profile containing information about travel routes, travel time, route repeatability, determine the location, direction of movement and speed of movement of the consumer's mobile device relative to the information display means based on the recorded values of the signal reception time from each mobile device and unique location identifiers signal reception;
to obtain data on the content displayed on the information display means and to establish its connection with the unique identifier of the consumer's mobile device, the time interval for the mobile device to be located near the information display means is determined and correlated with the data on the content of the displayed information and the exact time the information is displayed;
at the same time, to determine the true unique identifiers of mobile devices of consumers, they filter out randomized identifiers of mobile devices of consumers, including reading requests from a mobile device of a consumer by a device for receiving and analyzing signals, and then extracting data from requests received for a certain time interval and comparing the extracted data from all requests received for a certain time interval, and the exclusion of requests with different identifiers m abundant devices and repeating data.

2. The method according to claim 1, characterized in that as a unique identifier for mobile devices using the MAC address, IP address, TCP port number or any other identifier.

3. The method according to claim 2, characterized in that when using the MAC address as a unique identifier for mobile devices, Probe Request requests are used as requests from mobile devices of consumers, and data from WLAN Management data frames.

4. The method according to claim 1, characterized in that as a device for receiving and analyzing signals from mobile devices, consumers use a Wi-Fi radar or Wi-Fi scanner or Wi-Fi sniffer configured to operate in the scanning mode of mobile devices of consumers.

5. The method according to claim 1, characterized in that, as a device for receiving and analyzing signals from mobile devices of consumers, devices with a MAC address derandomization algorithm are used to obtain true MAC addresses of mobile consumers' devices.

6. The method according to claim 1, characterized in that when filtering randomized MAC addresses, a certain time interval is selected in accordance with the average time spent by the consumer's mobile device in the range of the device for receiving and analyzing signals.

7. The method according to claim 1, characterized in that in order to obtain data on unique identifiers of mobile devices of consumers, registration of request frames sent by mobile devices of consumers is carried out.

8. The method according to claim 1, characterized in that it further obtains video data from a location area of the information display means.

9. The method according to claim 8, characterized in that the video data is obtained using at least one video camera installed on or near the information display means, which determine the number of consumers in the camera's observation area for a certain period of time, and/or evaluate the direction consumer gaze and/or recognition of consumer emotions, the data obtained is used for subsequent statistical analysis and evaluation of the effectiveness of the displayed advertising information.

10. The method according to claim 9, characterized in that, based on the assessment of the direction of the gaze of consumers, an exception is made from the statistical analysis of random identifiers of mobile devices of consumers who did not interact with the means for displaying advertising information.

11. The method according to claim 1, characterized in that the consumer uses a smartphone, personal digital assistant (PDA), tablet computer, smart watch or any other wearable electronic device that can be used to uniquely identify and track the location.

12. The method according to claim 1, characterized in that the reception and transmission of data is carried out through a mobile communication network, a data network Wi-Fi or 3G/4G/5G.

13. The method according to claim 1, characterized in that in order to evaluate the effectiveness of the displayed information, a conversion rate of an offline audience into an online audience is determined.

14. The method according to claim 1, characterized in that the visualization of the data obtained as a result of statistical analysis, in graphical and/or digital form.

15. The method according to claim 1, characterized in that the advertisers access the data of statistical analysis.

16. The method according to claim 1, characterized in that carry out the selection and transmission of content that is interesting to one consumer or group of consumers to display on the information display means.

17. The method according to claim 1, characterized in that the consumer profile containing information about advertising preferences of consumers is obtained by sending a request and receiving a response from a database of consumer preferences and/or third-party services for providing information about consumers, while the profile contains data on the registration of mobile devices of users in social networks, wi-fi, the Internet and other networks; Information displayed to consumers on the Internet associated with mobile device identifiers.

18. The method according to claim 1, characterized in that the consumer profile contains information about age, gender, race, place of birth, marital status, information about friends and family.

19. The method according to claim 1, characterized in that they carry out continuous or periodic updating of these consumer profiles.

20. The method according to claim 1, characterized in that to assess the effectiveness of the displayed content and/or information display means, the number of consumers located near the information display means during the demonstration of specific content or content relevant to them is determined, and/or the number of consumers located near the means display information for a certain period of time, receive data on the budget of the advertising campaign with the subsequent determination of the cost of an audience unit for specific content and/or Unit oimosti audience information display means by dividing a predetermined budget to the corresponding number of consumers.

21. (canceled)

22. (canceled)

23. (canceled)

24. (canceled)

25. (canceled)
